(19) United States
(12) Patent Application Publication
(10) Pub. No.: US 2021/0096436 A1
(43) Pub. Date: Apr. 1, 2021

(54) ELECTROCHROMIC ELEMENTS AND DEVICES

(71) Applicant: NITTO DENKO CORPORATION, Osaka (JP)

(72) Inventor: Liping Ma, San Diego, CA (US)

(21) Appl. No.: 17/045,712

(22) PCT Filed: Apr. 2, 2019
(86) PCT No.: PCT/US2019/025410

§ 371 Date: Oct. 6, 2020

Related U.S. Application Data
(60) Provisional application No. 62/655,131, filed on Apr. 9, 2018.

(51) Int. Cl. G02F 1/153; G02F 1/155; G02F 1/1343; G02F 1/1524; G02F 1/1341

(52) U.S. Cl. CPC G02F 1/1533; G02F 1/155; G02F 2201/50; G02F 1/1524; G02F 1/1341; G02F 1/13439

(57) ABSTRACT

The present disclosure relates to electrochromic elements and devices including an electrochromic material having one or more optical properties that may be changed upon application of an electric potential. The device may include a conductive nanoparticle layer and/or a buffer layer. Upon provision of an electric potential above a threshold where electron tunneling may occur in the barrier layer, electrons are passed to or from the electrochromic material through the barrier layer resulting in a change to the optical properties of the electrochromic material. An opposite electric potential may be provided to reverse the change in the optical properties.

### CROSS-REFERENCE TO RELATED APPLICATION

This application claims the benefit of U.S. Provisional Application Ser. No. 62/655,131, filed Apr. 9, 2018, which is incorporated by reference herein in its entirety.

### FIELD

The present disclosure relates to electrochromic elements and devices, including electrochromic devices comprising a metal nanoparticle layer and/or a buffer layer.

### BACKGROUND

Electrochromic coatings or materials may be used for a number of different purposes. One such purpose includes controlling the amount of light and heat passing through a window based on a user-controlled electrical potential that is applied to an electrochromic coating. An electrochromic coating or material can reduce the amount of energy necessary to heat or cool a room, and can provide privacy. For example, a clear state of the electrochromic coating or material, having an optical transmission of about 60-80%, can be switched to a darkened state, having an optical transmission of between 0.1-10%, where the energy flow into the room is limited and additional privacy is provided. Due to large amounts of glass found in various types of windows, such as skylights, aircraft windows, automobile windows, and residential and commercial building windows, there may be energy savings provided by the use of an electrochromic coating or material on glass.

Despite the potential benefits that an electrochromic coating or device may provide, various issues may make current electrochromic devices undesirable for some applications. For example, in electrochromic devices utilizing an electrolyte, low ion mobility of the electrolyte may cause reductions in switching speeds and temperature-dependence issues. Ion intercalation may also occur in the electrochromic layer of an electrolyte-based device which causes the device volume to expand, and resultant mechanical stresses may limit the ability to operate between on and off cycles of the device. In such devices, there is a trade-off between high-speed switching and uniform switching because high ion mobility gives a very low internal device resistance for a larger area device, and this may lead to non-uniformity in application of an electric field across the whole device area. A further limitation of some electrochromic devices is the need for continuous application of electrical power in order to retain changes to the optical properties of the electrochromic material. Thus, there remains a need for further contributions in this area of technology.

### SUMMARY

Disclosed herein are electrochromic devices, which include an electrochromic element having one or more optical properties that can change from a first state to a second state upon application of an electric potential. The present disclosure also describes electrochromic devices having a blocking layer that exhibits insulative properties intended for retaining changes to the optical properties of the electrochromic material following application of the electric potential. Furthermore, the present disclosure relates to electrochromic devices exhibiting localized surface plasmon resonance properties intended to increase the differentiation of the opacity between the on and off state.

In addition, the present disclosure provides methods for the construction of the electrochromic elements and devices described herein.

### BRIEF DESCRIPTION OF THE DRAWINGS

FIG. 1 is a schematic illustration of one embodiment of an electrochromic element.

FIG. 2 is a schematic illustration of one embodiment of an electrochromic device.

FIG. 3 is a graphic illustration showing the total transmission (T %) as a function of wavelength (nm) of the device of Example EC-2 in an ON state and OFF state.

FIG. 4 is a graphic illustration showing the total transmission (T %) as a function of wavelength (nm) of a comparative embodiment of the device of Example CE-1 in an ON state and OFF state.

FIG. 5 is a graphic illustration showing the total transmission (T %) as a function of wavelength (nm) of an alternative embodiment of the device of Example EC-2 in an ON state and OFF state.

FIG. 6 is a graphic illustration showing the total transmission (T %) as a function of wavelength (nm) of an alternative embodiment of the device of Example CE-2 in an ON state and OFF state.

FIG. 7 is a graphic illustration showing the total transmission (T %) as a function of wavelength (nm) of an alternative embodiment of the device of Example CE-3 in an ON state and OFF state.

### DETAILED DESCRIPTION

As used herein, the term “transparent” means a property in which the corresponding material transmits or passes light. In one aspect, the transmittance of light through the transparent material may be about 50-100%, such as at least about 50%, at least about 60%, at least about 70%, at least about 80%, at least about 90%, at least about 95%, at least about 99%, about 50-60%, about 60-70%, about 70-80%, about 80-90%, about 90-95%, or about 95%-99%.

The term “light” as used herein means light in a wavelength region targeted by the electrochromic element or device. For example, when the electrochromic material or device is used as a filter of an image pickup apparatus for a visible light region, light in the visible light region is targeted, and when the electrochromic material is used as a filter of an image pickup apparatus for an infrared region, light in the infrared region is targeted.

The present disclosure generally relates to electrochromic devices that include an electrochromic element having one or more optical properties that may change from a first state to a second state upon application of an electric potential. More particularly, but not exclusively, the present disclosure relates to an electrochromic device exhibiting improved on- and off-state transmittance differentiation properties following application of the electric potential.

### Electrochromic Element:

Generally, an electrochromic element comprises a first electrode and a second electrode. A blocking layer and an electrochromic layer may be disposed between the first electrode and the second electrode. A conductive nanostructured metal layer may be disposed on the electrochromic layer. Additional layers, such as a protection layer, may also be present.

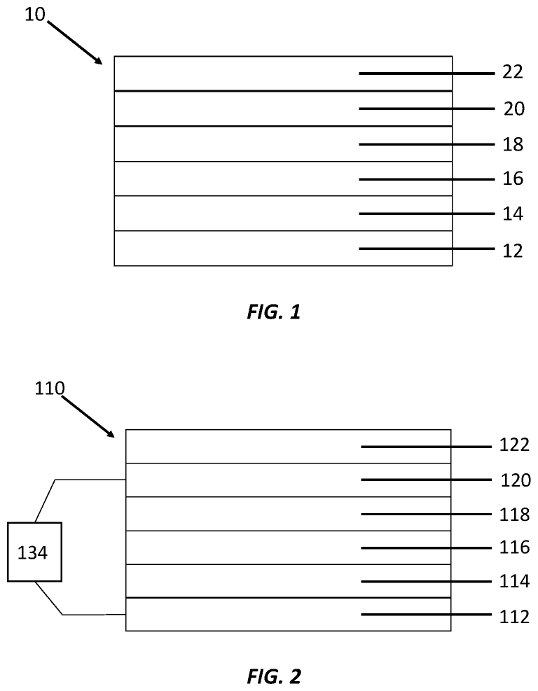

There are many potential configurations for the electrochromic element. One potentially useful configuration is depicted in FIG. 1. In FIG. 1, electrochromic element 10 comprises (e.g., in the order depicted): a first electrode (bottom electrode) 12, which is a conducting layer; a blocking layer 16, also known as a tunneling or barrier layer that is insulative; an electrochromic layer 18, which may change states from clear to darkened; a second electrode (top electrode) 20, which also is a conducting layer; and/or a protection layer 22.

In some embodiments, the recited elements are disposed in the recited order from bottom to top. In some embodiments, the recited elements are contacting one another in that order from bottom to top.

In some embodiments, the first electrode can comprise a conductive nanoparticle layer disposed or deposited upon a substrate. In some examples, the substrate can be non-conductive material, e.g., glass or plastic. In some cases, the substrate can be a conductive material, e.g., a conductive transparent metal oxide. In some embodiments, the substrate can be disposed upon the conductive nanoparticle layer.

In some embodiments, a conductive nanoparticle layer (not pictured) may be disposed between and in electrical communication with the electrochromic layer and the second electrode. In some embodiments, the conductive nanoparticle layer is sufficiently conductive that a second conductive electrode is not required and the conductive nanoparticle layer effectively serves as the second electrode.

In some embodiments, a buffer layer 14 can be disposed between and in optical and/or electrical communication with the first electrode and the blocking layer. In some embodiments, the buffer layer is a non-polymeric. In some embodiments, e.g., when there is no buffer layer, the surface of the conductive nanoparticle layer can be smooth. In some embodiments, e.g., when there is a buffer layer, the surface of the conductive layer can be rough.

### Electrochromic Device:

Generally, an electrochromic device comprises the electrochromic element described above, or elsewhere herein, and a power source in electrical communication with the first electrode and the second electrode, so as to provide an electric potential to the electrochromic device.

There are many potential configurations for the electrochromic device. One potentially useful configuration is depicted in FIG. 2. In FIG. 2, electrochromic element 110, comprises (e.g. in the order depicted): a first electrode (bottom electrode) 112, which is a conducting layer; a blocking layer 116, also known as a tunneling or barrier layer that is insulative; an electrochromic layer 118, which may change states from clear to darkened; a second electrode (top electrode) 120, which also is a conducting layer; a protection layer 122; and a power source 134.

In some embodiments, the recited elements are disposed in the recited order from bottom to top. In some embodiments, the recited elements are contacting one another in that order from bottom to top.

In some embodiments, the first electrode can comprise a conductive nanoparticle layer disposed or deposited upon a substrate. In some examples, the substrate can be non-conductive material, e.g., glass or plastic. In some cases, the substrate can be a conductive material, e.g., a conductive transparent metal oxide. In some embodiments, the substrate can be disposed upon the conductive nanoparticle layer.

In some embodiments, a conductive nanoparticle layer (not pictured) may be disposed between and in electrical communication with the electrochromic layer and the second electrode. In some embodiments, the conductive nanoparticle layer is sufficiently conductive that a second conductive electrode is not required and the conductive nanoparticle layer effectively serves as the second electrode.

In some embodiments, a buffer layer 114 can be disposed between and in optical and/or electrical communication with the first electrode and the blocking layer. In some embodiments, the buffer layer is a non-polymeric. In some embodiments, e.g., when there is no buffer layer, the surface of the conductive nanoparticle layer can be smooth. In some embodiments, e.g., when there is a buffer layer, the surface of the conductive layer can be rough.

Alternative arrangements of the layers of the electrochromic element and/or electrochromic device are also envisioned. For example, in one embodiment, the blocking layer that provides the tunneling dielectric channel may be positioned between the top electrode and the electrochromic layer. In another embodiment, the element can comprise a first electrode; a conductive nanostructured layer; and an electrochromic layer, wherein the conductive nanostructured layer can be disposed between the first electrode and the electrochromic layer.

### Electrodes:

The electrochromic elements and devices described herein comprise an electrode on the top and the bottom of the various electrochromic element or device layers. In some embodiments, the electrodes (“electrodes,” “the electrodes,” or a similar phrase is used as shorthand herein for “first electrode and/or second electrode”) may be formed on a bonding layer and/or a substrate. The electrodes may comprise a transparent material. When one or more of the electrodes are transparent, light can be efficiently transmitted to the inner layers of the elements or devices, and may interact with the electrochromic material.

The electrodes may comprise a transparent conductive oxide, dispersed carbon nanotubes on a transparent substrate, partly arranging metal wires on a transparent substrate, or combinations thereof. In some embodiments, the electrodes may be formed from a transparent conductive metal or metal oxide material having good transmissivity and conductivity. Examples of transparent conductive oxides include indium tin oxide (ITO), zinc oxide, gallium-doped zinc oxide (GZO), indium zinc oxide (IZO), aluminum-doped zinc oxide (AZO), tin oxide, antimony-doped tin oxide (ATO), fluorine-doped tin oxide (FTO), and niobium-doped titanium oxide (TNO). An example of a transparent conductive metal is Al. In some examples the electrodes may comprise a conductive polymer material, a material containing Ag, Ag nanoparticles, carbon nanotubes or graphene. Of the transparent conductive oxide materials identified above, FTO may be selected for heat resistance, reduction resistance, and conductivity, and ITO may be selected for conductivity and transparency. In the event a porous electrode is formed and calcined, then it may be desirable for the transparent conductive oxide to have high heat resistance. One or more of the electrodes may contain one of these materials, or one or more of the electrodes may have a multi-layer structure containing a plurality of these materials. In an alternative form, one or more of the electrodes may be formed from a reflective material such as a Group 10 of 11 metal, non-limiting examples of which include Au, Ag, and/or Pt. Embodiments in which the reflective material is a Group 13 metal, such as aluminum (Al) are also possible.

In some embodiments, the first electrode is indium tin oxide. In some examples, the thickness of the first electrode (e.g. an ITO electrode) is about 10 nm to about 150 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 15-25 nm, or about 20 nm.

In some embodiments, the second electrode is Al. In some examples, the thickness of the second electrode (e.g. an Al electrode) is about 10 nm to about 150 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 15-25 nm, or about 20 nm.

### Buffer Layer:

In some examples, a buffer layer can be disposed between the first electrode and the blocking layer. In some embodiments, the buffer layer can have a surface comprising a nanostructured or rough morphology. In some embodiments, the buffer layer can have a top surface having the same or similar morphology as described with reference to the conductive nanoparticle layer. In some embodiments, the buffer layer can comprise a non-polymeric organic compound that may comprise an optionally substituted aromatic ring. In some cases, the buffer layer comprises a bisphenyl pyridine compound. A suitable bisphenyl pyridine compound can be a 3,5-diphenyl pyridine. In one form, the bisphenyl pyridine compound may include the bisphenyl pyridine compounds described in U.S. Pat. No. 9,051,284, which is incorporated by reference in its entirety for its description of organic compounds, e.g., bisphenyl pyridine compounds. In one particular but non-limiting form, the bisphenyl pyridine has the following structure:

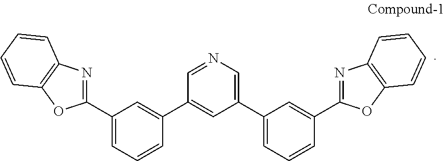 [SMILES: c1cc(-c2cncc(-c3cccc(-c4nc5ccccc5o4)c3)c2)cc(-c2nc3ccccc3o2)c1]

Other suitable buffer layer materials can include the following structures:

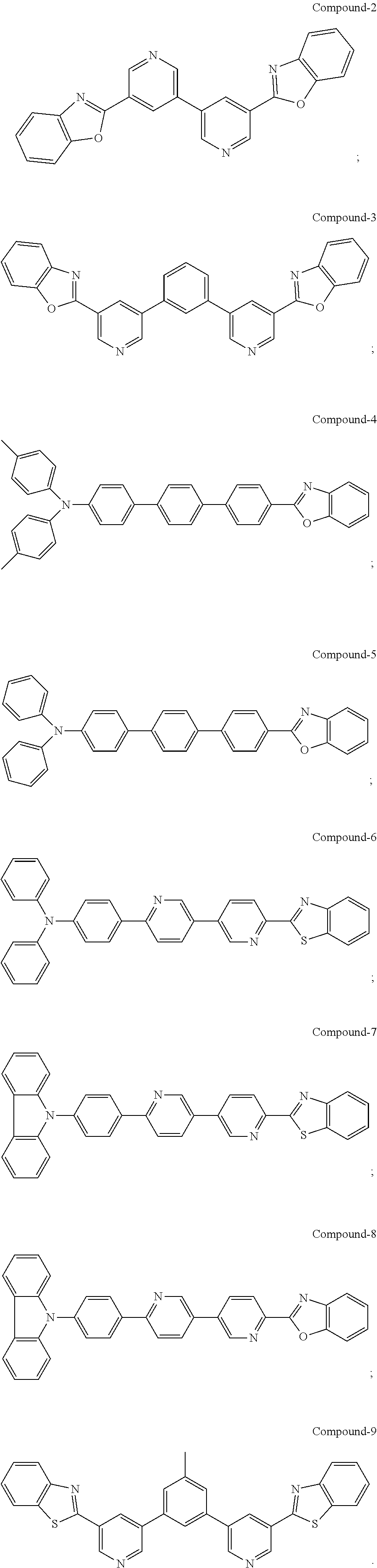

In some embodiments, the buffer layer can have a thickness between about 0.1 nm to about 50 nm. In some examples, the buffer layer can have a thickness of about 0.1-0.5 nm, about 0.5-1 nm, about 1-1.5 nm, or about 1.5-2 nm; about 2-2.1 nm, about 2.1-2.2 nm, about 2.2-2.3 nm, about 2.3-2.4 nm, about 2.4-2.5 nm, about 2.5-2.6 nm, about 2.6-2.7 nm, about 2.7-2.8 nm, about 2.8-2.9 nm, or about 2.9-3 nm; about 3-3.1 nm, about 3.1-3.2 nm, about 3.2-3.3 nm, about 3.3-3.4 nm, about 3.4-3.5 nm, about 3.5-3.6 nm, about 3.6-3.7 nm, about 3.7-3.8 nm, about 3.8-3.9 nm, about 3.9-4 nm, about 4-4.1 nm, about 4.1-4.2 nm, about 4.2-4.3 nm, about 4.3-4.4 nm, about 4.4-4.5 nm, about 4.5-4.6 nm, about 4.6-4.7 nm, about 4.7-4.8 nm, about 4.8-4.9 nm, or about 4.9-5 nm; about 5-5.1 nm, about 5.1-5.2 nm, about 5.2-5.3 nm, about 5.3-5.4 nm, about 5.4-5.5 nm, about 5.5-5.6 nm, about 5.6-5.7 nm, about 5.7-5.8 nm, about 5.8-5.9 nm, about 5.9-6 nm, about 6-6.5 nm, about 6.5-7 nm, about 7-7.5 nm, about 7.5-8 nm, about 8-9 nm, about 9-10 nm, about 10-15 nm, about 15-20 nm, about 20-30 nm, about 30-40 nm, about 40-50 nm, about 2 nm, about 3 nm, about 4 nm, about 5 nm, or about 6 nm.

### Blocking Layer:

In some embodiments, the electrochromic element can further comprise a blocking layer. The blocking layer may also be termed a barrier layer or a tunneling layer. In some embodiments, the blocking layer prevents electronic charges from moving through the device from one electrode into the other, while retaining the injected electrons from the cathode for the coloration of the electrochromic layer. In some embodiments, the blocking layer can reduce charge leakage. In some embodiments, the blocking layer can increase coloration efficiency. Further, the first electrode can also be electrically isolated or separated from the electrochromic layer by the blocking layer, which includes an electrically insulative material. The term “electrically insulative” refers to the reduced transmissivity of the layer to electrons and/or holes. In one form, the electrical isolation or separation between these layers may result from increased resistivity within the blocking layer. In addition, the first electrode can be in electrical communication with the buffer layer, which can be in electrical communication with the blocking layer, which can be in electrical communication with the electrochromic layer, which can be in electrical communication with the second electrode.

The blocking layer may comprise one or more electrically insulative materials, including inorganic and/or organic materials that exhibit electrically insulative properties. In some embodiments, the application of a suitable electric potential, such as a voltage pulse, to the first electrode layer and the second electrode layer of the device, may cause band bending to occur in the blocking layers in order to pass electrons to or from the electrochromic layer. The electrons that are being charged to or discharged from the electrochromic layer can alter at least one optical property, such as transmittance, of the electrochromic layer. In one form, the blocking layer may comprise oxide and/or nitride compounds, such as, for example, aluminum oxide, tantalum oxide, yttrium oxide, calcium oxide, magnesium oxide and/or zirconium oxide, Si₃N₄, and AlN. In some embodiments, the blocking layer may comprise aluminum oxide or tantalum oxide. In other examples, the blocking layer may comprise a stoichiometric metal oxide layer, such as Al₂O₃, Ta₂O₅, Y₂O₃, CaO, MgO or ZrO₂. In some cases, the blocking layer may be a non-stoichiometric metal oxide layer. In some embodiments, the blocking layer is Al₂O₃.

The blocking layer can have a thickness in the range of about 10 nm to about 1000 nm, about 10-20 nm, about 20-30 nm, about 30-40 nm, about 40-50, about 50-60, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-250 nm, about 250-300 nm, about 300-400 nm, about 400-500 nm, about 500-600 nm, about 600-700 nm, about 700-800 nm, about 800-900 nm, about 900-1000 nm, about 100 nm, or about 200 nm. In some embodiments, the blocking layer is effective for impeding or entirely blocking, on a selective basis, electrons from moving through the blocking layers. Thus, the blocking layer may be effective for maintaining (in whole or in part) charges injected in or discharged from the electrochromic materials of the electrochromic layer to be stored without continued application of an electric potential.

### Electrochromic Layer:

The electrochromic layer comprises an electrochromic material. In one form, the electrochromic material comprises an electrochromic compound and a matrix material. In one particular but non-limiting form, the electrochromic material comprises a metal oxide such as WO₃. Alternatively, the electrochromic layer can comprise any electrochromic material or compound that may undergo changes in optical transmittance and/or absorption. The optical transmittance or absorption may change when the electrochromic layer is in a charged-state that can be achieved by, for example, the charged injection from the first electrode through the blocking layer and into the electrochromic layer under an applied voltage pulse above a critical value where electron tunneling occurs.

In some embodiments, the electrochromic material includes charge sensitive materials that may be effected by localized plasma resonance. In some forms, the electrochromic material may include both inorganic and/or organic materials. When an organic compound is included, it may be a low-molecular weight organic compound, a high-molecular weight organic compound, or a combination thereof. Each of these types of materials may be colored (or darkened) by the application of an electric potential as described herein. Non-limiting examples of high-molecular weight organic compounds of this type include those containing a pyridinium salt, and the compound can be, for example, a viologen-based high-molecular weight compound. In some embodiments, the electrochromic material can include a low-molecular weight organic compound. The electrochromic material may also include a compound that undergoes changes in optical properties, such as from a decolored form to a colored form, through an oxidation reaction (i.e., by giving up electrons) or a reduction reaction (i.e., by accepting electrons). In some embodiments, the electrochromic material includes one or more anodic electrochromic materials and/or one or more cathodic electrochromic materials.

The electrochromic layer may have any suitable thickness, such as about 50-500 nm, about 50-70 nm, about 70-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-350 nm, about 350-400 nm, about 400-450 nm, about 450-500 nm, about 100-300 nm, about 200-400 nm, about 300-500 nm, about 100 nm, or about 200 nm. The electrochromic layer can be thin enough to allow the translation of the buffer layer morphology therethrough to affect the resultant morphology of the conductive nanostructured layer.

The electrochromic layer may be fixed to the blocking layer, the first electrode layer, and/or the second electrode layer. Fixing the electrochromic layer is possible because in this layer, at the time of the adjustment of charge imbalance, charge exchange between the electrodes needs only to occur; there is no need to cause the electrochromic material to diffuse through an electrolyte to reach the electrodes. In addition, as described above, in devices where electrolytes are present and the electrochromic material can freely diffuse through the electrolyte, it may cause the transformation of a colored form into a decolored form as the material reaches an electrode. In these instances, a feature for reducing substance transportation, such as a partition wall, could be used for suppressing the transformation. In contrast, when the electrochromic material may be fixed to the electrodes, or presented in a form without the presence of electrolytes, there may be a reduced likelihood of the transformation of the colored form into the decolored form.

Non-limiting methods of fixing the electrochromic layer involve, for example, bonding the electrochromic material to an insulating material through a functional group in a molecule of the electrochromic material, causing an insulating material to retain the electrochromic material in a comprehensive manner (e.g., in a film state) through the utilization of a force, such as an electrostatic interaction, or causing the electrochromic material to physically adsorb to an insulative material. A method involving chemically bonding a low-molecular weight organic compound serving as the electrochromic material to a porous insulative material through a functional group thereof, or a method involving forming a high-molecular weight compound serving as the electrochromic material on the insulative material may be used when a quick reaction of the electrochromic material is desired. The former method may include fixing the low-molecular weight organic compound serving as the electrochromic material onto a fine particle oxide electrode, such as aluminum oxide, titanium oxide, zinc oxide, or tin oxide, through a functional group, such as an acid group (e.g., a phosphoric acid group or a carboxylic acid group). The latter method is, for example, a method involving polymerizing and forming a viologen polymer on an insulative and/or tunneling dielectric material and may include electrolytic polymerization.

### Conductive Nanoparticle Layer:

In some embodiments, a conductive nanoparticle layer is present in the electrochromic element or device. As used herein, the term “nanoparticle layer” includes a nanostructured layer. In some examples, the conductive nanoparticle layer can be optically transmissive. Optically transmissive refers to at least 50% total transmittance of visible light through the conductive nanoparticle layer, e.g. about 50-100%, such as at least about 50%, at least about 60%, at least about 70%, at least about 80%, at least about 90%, at least about 95%, at least about 99%, about 50-60%, about 60-70%, about 70-80%, about 80-90%, about 90-95%, or about 95%-99%. In some embodiments, the conductive nanostructured layer can comprise a metal. In some embodiments, the conductive nanoparticle layer can comprise a metal nanoparticle or nanostructured layer. In some embodiments, the conductive nanoparticle layer is positioned between the electrochromic layer and the second electrode. In some examples, the conductive nanoparticle layer can be deposited directly on top of the electrochromic layer. In some embodiments, the conductive nanoparticle layer can serve as the second electrode.

In some embodiments, the conductive nanostructured layer can comprise a noble metal. In some embodiments, the noble metal can be Ag, and/or Au. In some examples, the conductive nanostructured layer can comprise a Group 13 metal. In some embodiments, the Group 13 metal can comprise Al. In some embodiments, the conductive nanostructured layer can comprise a Group 11 metal. In some embodiments, the Group 11 metal can be Cu and/or Ag. In some embodiments, the conductive nanostructured layer can comprise nanoparticles having an average diameter of between 10 nm to 1 μm. In some embodiments, the conductive nanostructured layer can comprise a plurality of discrete nanoparticles.

In some embodiments, the conductive nanoparticle layer can have a thickness between about 2 nm and 50 nm, about 2-3 nm, about 3-4 nm, about 4-5 nm, about 5-6 nm, about 6-7 nm, about 7-8 nm, about 8-9 nm, about 9-10 nm, about 10-11 nm, about 11-12 nm, about 12-13 nm, about 13-14 nm, about 14-15 nm, about 15-16 nm, about 16-17 nm, about 17-18 nm, about 18-19 nm, about 19-20 nm, about 20-21 nm, about 21-22 nm, about 22-23 nm, about 23-24 nm, about 24-25 nm, about 25-26 nm, about 26-27 nm, about 27-28 nm, about 28-29 nm, about 29-30 nm, about 30-40 nm, about 40-50 nm, about 2-30 nm, about 10-20 nm, about 14-16 nm, about 10 nm, about 15 nm, about 20 nm, or about 30 nm. In some embodiments, the conductive layer can have a nanostructure up to 1 micrometer (micron).

In some embodiments, the nanoparticle conductive layer (if a buffer layer is present) has a complementary rough morphology due to the corresponding rough surface of the buffer layer projecting through the thin blocking layer and electrochromic layer.

### Protective Layer:

In some embodiments, the electrochromic element or device can comprise a protective layer. In some embodiments, the protection layer can comprise a polymer or other material to protect the electrochromic element device from moisture, oxidation, physical disfigurement, etc. Suitable protective layers and or materials are described in the art.

### Power Source:

A power source (FIG. 2) is in electrical communication with the first electrode and the second electrode layer of the electrochromic device. The power source may be used to selectively provide an electric potential such as a voltage pulse to the first electrode and/or the second electrode to effect desired passage of electrons through the blocking layer to or from the electrochromic material of the electrochromic layer.

### Applications of the Electrochromic Device:

The electrochromic elements and devices described herein can be used for a number of different purposes and applications. For example, an electrochromic device could be used in a window member that includes a pair of transparent substrates with the electrochromic device positioned between the transparent substrates. Through use of the device, the window member can adjust the quantity of light and heat that may be transmitted through the transparent substrates. In addition, the window member can include a frame which supports the electrochromic device, and the window member can be used in an aircraft, an automobile, a house, or the like. In some embodiments, the window member comprising the electrochromic device can effect a difference in the transmission of light therethrough of at least about 45%, at least about 50%, at least about 55%, at least about 60%, at least about 65%, at least about 70%, at least about 75%, at least about 80%, about 45-100%, about 45-55%, about 50-60%, about 60-70%, about 70-80%, about 80-90%, about 90-100%, about 45-70%, or about 70-100%, between the off and on states at a selected wavelength of light, e.g., 500 nm.

One or more optical properties of the electrochromic material of the electrochromic layer may be changed when an electric potential is provided between the first electrode and the second electrode. The change in the optical properties of the electrochromic material will not occur until the electric potential reaches a threshold. At the threshold, electron tunneling may occur in the blocking layer in order to permit passage of electrons through the blocking layer to or from the electrochromic layer. In this respect, the electrochromic layer may be described as being in selective electrical communication with the at least one of electrodes by virtue of the insulative effect (which may be overcome) of blocking layer.

In one embodiment, activation of (or turning on) the electrochromic material of the electrochromic layer involves injecting electrons into the electrochromic layer as the first electrode is held at a ground potential and a positive voltage is applied to the second electrode. In various embodiments, the positive voltage (Vpp) may be from about 1 to about 5 volts, at least 12 volts when the positive read or operating voltage, Vdd, is about 5 volts, and from about 20 volts to about 25 volts, although other variations are contemplated. In order to deactivate or turn off the electrochromic material of layer, the first electrode can be held at a ground potential, and a negative voltage is applied to the second electrode, or both the first electrode can be held at a ground potential and a positive voltage is applied to the second electrode. In various embodiments, the negative voltage (Vpp) may be, for example at least −1 volt, −2 volts, −4 volts, −5 volts, up to −12 volts (e.g., when the negative read or operating voltage (Vdd) is about −2 volts), or from about −20 volts to about −25 volts. A ground potential generally refers to a virtual ground potential or a voltage level of about 0V. Programming is believed to be effected by conventional electron injection. Alternatively, holes may be stored on the electrochromic layer by supplying a negative voltage (e.g., −Vpp) to the control gate/gate electrode. In a further alternative embodiment, a reference cell, “unprogrammed” transistor, or transistor storing a “0” binary logic state, may be programmed to a complementary binary logic state using a bias opposite to that of the programmed cell(s), leading to a greater delta Vₜ between the programmed-unprogrammed cell pairs (e.g., the complementary binary logic states). The greater threshold voltage difference enhances the margin over which the devices are functional, increases data retention time, and/or allows read operations under less stringent (e.g., subthreshold swing) conditions.

The electrochromic device is insulated under normal operation. The applied voltage pulse is only needed for switching states of the electrochromic layer. Electron conduction may only occur upon application of a critical voltage pulse necessary to push electrons into or out of the electrochromic layer. Moreover, given that the device is insulated under normal operation and the electrochromic layer is insulated from the electrodes, the leakage of charges into or out of the electrochromic material is reduced, minimized, or eliminated.

The insulating effect of the blocking layer may provide a wide band gap insulating effect, while the electrochromic layer, which could be a semiconductor, has a lower-level conduction band that can keep the electron[s] trapped therein as the “memory” effect (non-volatile), which reduces, minimizes and/or insures no power consumption under normal device operation unless a switching process is occurring. Similarly, this arrangement can reduce, minimize and/or eliminate the issue of leakage suffered in other forms of electrochromic devices. In addition, the insulative properties of the devices described herein allow the voltage applied from the power supply to the electrochromic material of the electrochromic layer to be uniformly applied without potential drop to the electrode since the resistance of the device is much larger than the resistance of the electrode. Other forms of electrochromic devices may generally be highly conductive and in applications for a larger area such as a window, the device has a much lower resistance and the electrode layer's resistance can be comparable to or less than the device's resistance. This may result in a drop across the electrode layer that may cause non-uniformity in application of the power supply for applications of these devices in larger area applications. In contrast, as indicated above, the devices described herein may be effective for minimizing, reducing or eliminating the occurrence of this issue.

In some embodiments, the electrochromic material of the electrochromic layer can trap both electrons and holes. When a voltage pulse is supplied to the two electrodes above a critical value, the band bending at the blocking layer may cause electron injection from the working electrode into the electrochromic material of the electrochromic layer. The charges will be stored in the electrochromic layer due to the insulative effect provided by the blocking layer. The stored charges in the electrochromic material of the electrochromic layer may cause a color change or a change in transmission/absorption. For example, it may cause a change from a former clear state to a high absorption (darkened) state.

In one form, activation of (or turning on) the electrochromic material of the electrochromic layer may involve supplying a first positive voltage to the second electrode, and holding the first electrode at a ground potential. In one form, the first and second positive voltages are conventional read voltages (e.g., Vdd) less than Vpp, and may generally be from about 1.5V to 9V, about 1-1.5V, about 1.5-2V, about 2-2.5V, about 2.5-3V, about 3-3.5V, about 3.5-4V, about 4-4.5V, about 4.5-5V, about 5-5.5V, about 5.5-6V, about 6-6.5V, about 6.5-7V, about 7-7.5V, about 7.5-8V, about 8.5-9V, about 9-9.5V, or about 9.5-10V.

Deactivation of (or turning off) the electrochromic material of the electrochromic layer involves the inverse of the activation/turning on procedure. For example, if the electrochromic layer is activated/turned on by supplying a positive voltage to the first electrode, the deactivation/turning off operation involves supplying a negative voltage of about the same magnitude to the second electrode while the source electrode is held at a ground potential. Alternatively, if the electrochromic layer is activated by supplying a negative voltage to the second electrode, the deactivation/turning off operation involves supplying a positive voltage of about the same magnitude to the control gate/gate electrode while the source electrode and drain electrode are held at a ground potential.

The term “plasmon” refers to collective oscillation of free electrons on a metal surface that is excited by an external electric field such as light. Because electrons are electrically charged, polarization occurs due to the density distribution of free electrons that is caused by oscillation of electrons. It is believed that the presence of conductive nanostructured materials provides a site for the polarization. A phenomenon in which the polarization and an electromagnetic field are combined is referred to as “plasmon resonance.” In particular, a resonance phenomenon that occurs between light and plasma oscillations of free electrons generated on a metal microstructure or a metal particle surface can be referred to as localized surface plasmon resonance (LSPR).

Specifically, when collective oscillation of free electrons on a metal particle surface is excited by an external electric field such as light, density distribution of electrons and polarization accompanying the density distribution are generated by the oscillation. As a result, an electromagnetic field that is localized in the vicinity of the particle is generated.

### Preparation of the Electrochromic Elements and Devices:

Some embodiments include a method for preparing an electrochromic element. In some embodiments, the method comprises depositing an electroconductive material upon a substrate; depositing a buffer layer upon the electroconductive material, the resulting buffer layer having a nanostructured morphology thereon; depositing an electrically blocking material layer upon the buffer layer, the blocking layer sufficiently thin enough to pass the nanostructured morphology therethrough; depositing an electrochromic layer upon the blocking layer; depositing a nanoparticle conductive layer upon the electrochromic layer, wherein the electrochromic layer is of sufficient thinness to pass the nanostructured morphology from the buffer layer and effecting a complementary morphology in the conductive layer; optionally depositing an electroconductive material upon the nanoparticle conductive layer; and optionally adding a protective layer to the element. In some embodiments, the method for preparing an electrochromic device comprises the steps described above for the electrochromic element, further comprising adding a power source in electrical communication with the first and last applied electroconductive materials. In some embodiments, the buffer layer can be a nanostructured or rough material or surface morphology as described earlier herein. In some embodiments, the depositing can be by vapor deposition. In some embodiments, the depositing can be by sputtering. In some embodiments, the first electroconductive layer comprises indium tin oxide and is 20 nm thick. In some embodiments, the buffer layer comprises compound 1 and is 4 nm thick. In some examples, the blocking layer comprises Al₂O₃ and is 100 nm thick. In some cases, the electrochromic layer comprises WO₃ and is 200 nm thick. In some embodiments, the conductive nanoparticle layer comprises Ag and is 15 nm thick. In some examples, the second electroconductive layer comprises Al and is 200 nm thick.

### Examples

The following Examples are intended to be illustrative of the embodiments of the disclosure, but are not intended to limit the scope or underlying principles in any way.

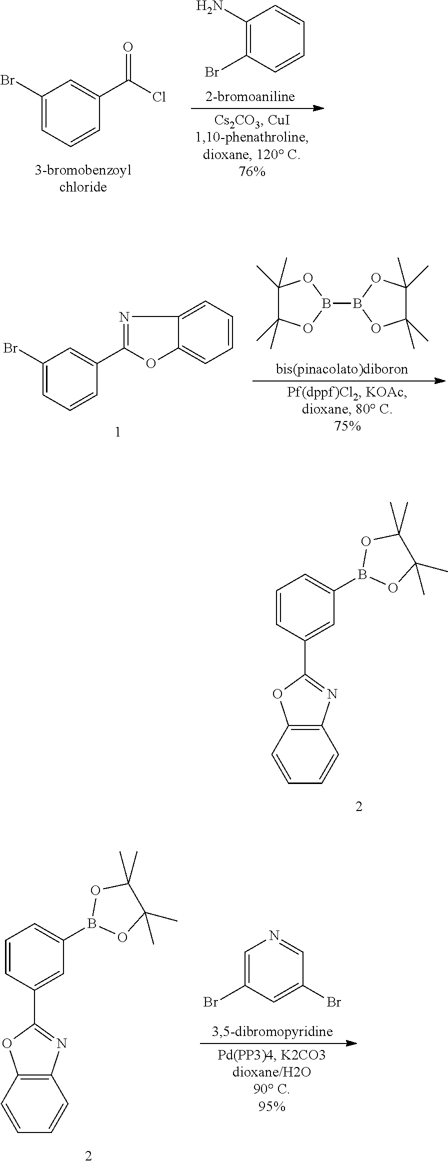

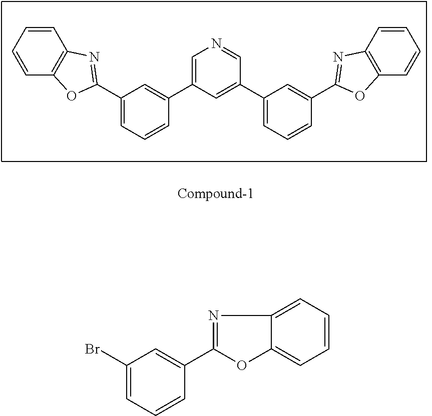 [SMILES: c1cc(-c2cncc(-c3cccc(-c4nc5ccccc5o4)c3)c2)cc(-c2nc3ccccc3o2)c1 ; Brc1cccc(-c2nc3ccccc3o2)c1]

### 2-(3-bromophenyl)benzo[d]oxazole

A mixture of 3-bromobenzoyl chloride (10.0 g, 45.6 mmol), 2-bromoaniline (7.91 g, 46 mmol), Cs₂CO₃ (30 g, 92 mmol), CuI (0.437 g, 2.3 mmol) and 1,10-phenanthroline (0.829 g, 4.6 mmol) in anhydrous 1,4-dioxane (110 ml) was heated at 120° C. for 8 h. After cooling to RT, the mixture was poured into ethyl acetate (300 ml), worked up with water (250 ml). The aqueous solution was extracted with dichloromethane (300 ml). The organic phase was collected, combined, and dried over Na₂SO₄. Purification by a short silica gel column (hexanes/ethyl acetate 3:1) gave a solid which was washed with hexanes to give a light yellow solid (9.54 g, 76% yield).

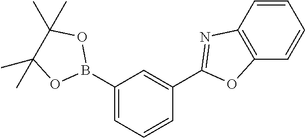 [SMILES: CC1(C)OB(c2cccc(-c3nc4ccccc4o3)c2)OC1(C)C]

### 2-(3-(4,4,5,5-tetramethyl-1,3,2-dioxaborolan-2-yl)phenyl)benzo[d]oxazole

A mixture of 2-(3-bromophenyl)benzo[d]oxazole (2.4 g, 8.8 mmol), bis(pinacolato)diboron (2.29 g, 9.0 mmol), [1,1′-Bis(diphenylphosphino)ferrocene]dichloropalladium (0.27 g, 0.37 mmol), and potassium acetate (2.0 g, 9.0 mmol) in anhydrous 1,4-dioxane (50 mL) was degassed, then heated at 80° C. overnight. After cooling to RT, the mixture was poured into ethyl acetate (100 ml). After filtration, the solution was absorbed on silica gel and purified by flash chromatography (hexanes/ethyl acetate 4:1) to give a white solid (2.1 g in 75% yield).

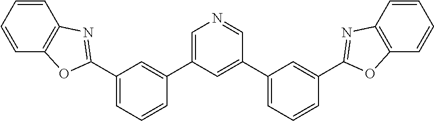 [SMILES: c1cc(-c2cncc(-c3cccc(-c4nc5ccccc5o4)c3)c2)cc(-c2nc3ccccc3o2)c1]

Compound-1:

A mixture of 3,5-dibromopyridine (0.38 g, 1.6 mmol), 2-(3-(4,4,5,5-tetramethyl-1,3,2-dioxaborolan-2-yl)phenyl)benzo[d]oxazole (1.04 g, 3.1 mol), Pd(PPh₃)₄ (0.20 g, 0.17 mmol) and potassium carbonate (0.96 g, 7.0 mmol) in dioxane/water (40 ml/8 ml) was degassed and heated at 90° C. overnight under argon. After cooling to RT, the precipitate was filtered and washed with methanol to give a white solid (0.73 g, in 95% yield).

### Preparing Electrochromic Device EC-1

An electrochromic device (Example EC-1) was prepared according to the following process. A glass substrate was prepared by cutting a 1.1 mm thick glass substrate to a 5 cm×5 cm size. The glass substrate was then washed with detergent and DI water, rinsed with fresh DI water and sonicated for about 1 hour. The glass substrate was then soaked in isopropanol (IPA) and sonicated for about 1 hour. The glass substrate was then soaked in acetone and sonicated for about 1 hour. The glass substrate was then removed from the acetone bath and dried with nitrogen gas at room temperature. The glass substrate was then loaded into a vacuum deposition chamber (Angstrom Engineering, Inc.) set at 2×10⁻⁷ torr and a described deposition rate. First, 20 nm thick metallic ITO films were deposited at O₂ pressure (PO₂) of 10⁻⁵ torr as the transparent source and drain electrodes or as a single electrode disposed upon the substrate. Then, a buffer layer of Compound-1 was deposited under vacuum of 10⁻⁷ torr, where the deposition rate of a Compound-1 (4 nm) film was about 2 Angstroms/second for the remaining layers. Then, an Al₂O₃ blocking layer was deposited under vacuum of 10⁻⁷ torr, where the deposition rate of an Al₂O₃ (100 nm) film was about 2 Angstroms/second for the remaining layers. A WO₃ thin film [about 200 nm] (electrochromic material/layer) as described in U.S. Pat. No. 8,610,992 was deposited on the Al₂O₃ film. A thin layer of Ag was deposited as the electrode on the WO₃ layer (electrochromic material layer). Electrical connections were connected between a power source (Tektronix, Inc., Beaverton, Oreg., USA, Kethley 2400 sourcemeter) and switched electrical connections with the electrodes to enable selective application of potential to the top or second electrode (on) or to the bottom or first electrode (off).

The devices of Examples CE-1, CE-2, CE-3, and EC-2 were made in a manner similar to that described above with respect to the device of Example EC-1, except as indicated in TABLE 1 below.

TABLE 1

| | | | Buffer | Blocking | Electrochromic | Nanoparticle | |
|---|---|---|---|---|---|---|---|
| Example | Substrate | Electrode | layer | layer | layer | layer | Electrode |
| CE-1 | Glass | ITO | None | Al₂O₃ | WO₃ | None | ITO |
| | | | | (200 nm) | (200 nm) | | (150 nm) |
| CE-2 | Glass | ITO | BC-1 | Al₂O₃ | WO₃ | None | ITO |
| | | | (2 nm) | (200 nm) | (400 nm) | | (110 nm) |
| CE-3 | Glass | ITO | None | Al₂O₃ | WO₃ | Ag | None |
| | | | | (100 nm) | (200 nm) | (15 nm) | |
| EC1 | Glass | ITO | BC-1 | Al₂O₃ | WO₃ | Ag | None |
| | | | (2 nm) | (100 nm) | (200 nm) | (15 nm) | |
| EC2 | Glass | ITO | BC-1 | Al₂O₃ | WO₃ | Ag | None |
| | | | (4 nm) | (100 nm) | (200 nm) | (15 nm) | |

### Transmissive (T %)

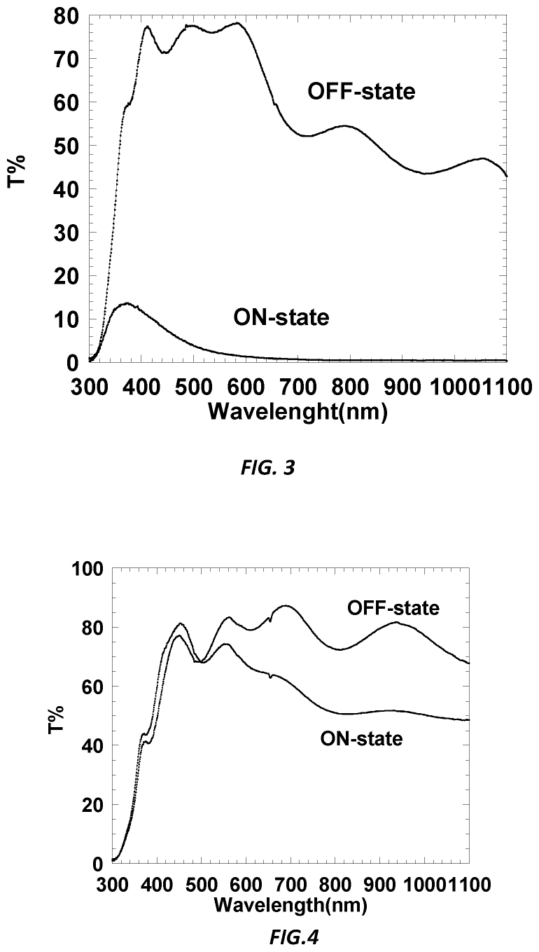

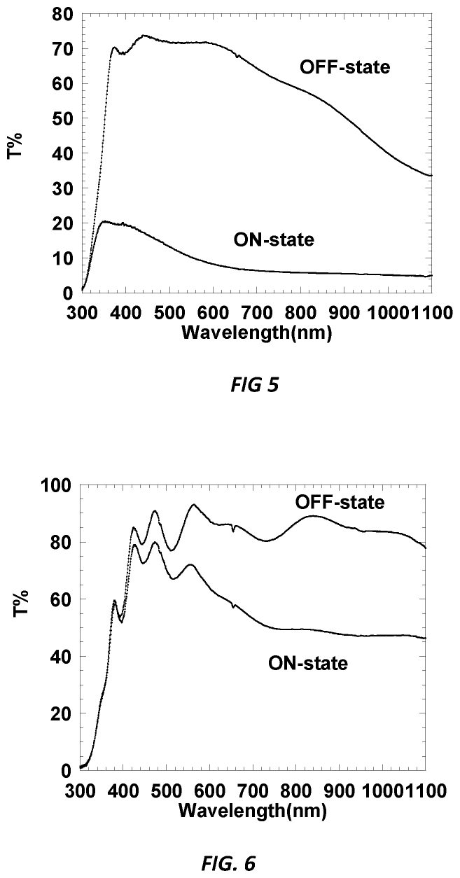

In addition, total light transmittance data of the examples were measured by using the measurement system similar to that described in U.S. Pat. No. 8,169,136 (shown there and described in FIG. 4 (MCPD 7000, Otsuka Electronics, Inc., Xe lamp, monochromator, and integrating sphere equipped). FIGS. 3-7 show the total light transmittance spectrum of the embodiments being tested (Samples EC-2, CE-1, EC-2, CE-2, CE-3, respectively).

The Example EC-2 device (FIG. 1) with a metal nanoparticle layer (15 nm) and a buffer layer (4 nm) as described herein was positioned onto a Filmetrics F10-RT-YV reflectometer (Filmetrics, San Diego, Calif., USA), and the total transmission therethrough (T %) was determined over varying wavelengths of light. The results are shown in FIG. 3. At about 500 nm, total transmission (T %) was about 4% at 500 nm in the On-state, and about 78% at 500 nm in the Off-state.

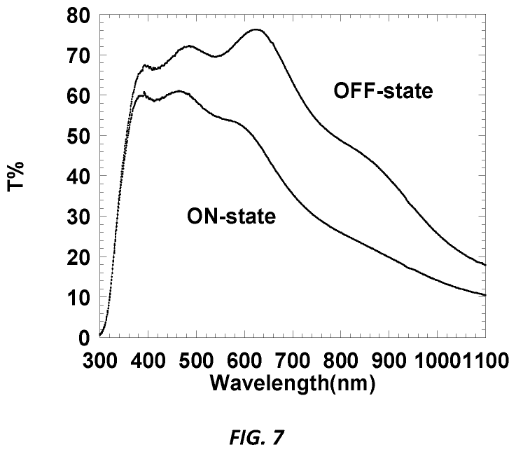

The T % at various wavelengths for devices with EC-1 (buffer layer 2 nm thick), CE-1 (no metal nanoparticle layer and no buffer layer); CE-2 (no metal nanoparticle layer with a buffer layer); CE-3 (metal nanoparticle layer and no buffer layer) are shown in FIGS. 5, 4, 6 and 7 respectively. At 500 nm, they showed a difference between on and off state T %, at 500 nm of 58.2% (FIG. 5, 2 nm buffer layer and 15 nm metal nanoparticle layer); of 0% (FIG. 4, No buffer layer and no metal nanoparticle layer); of 10% (FIG. 6, buffer layer and no metal nanoparticle layer); and of 14% (FIG. 7, No buffer layer and metal nanoparticle layer). As shown, the embodiments of a buffer layer alone and a metal nanoparticle layer alone show improvement over the comparative embodiment with neither layer. Furthermore, the embodiments with both conductive nanoparticle layer and buffer layer show synergistic benefits as compared to the comparative embodiment with neither layer, and/or either one or the other layer.

### % Transmission

Additional results (EC-1, EC-2, CE-3) are also shown in Table 2 below.

TABLE 2

| | T % | T % | | |
|---|---|---|---|---|
| Buffer layer thickness | Initial-state @ 630 nm | ON-state @ 630 nm | $\frac{T - initial}{T - On}$ | T_{clear}/T_{colored}/ EC(nm) |
| 0 nm | 76 | 48 | 1.58 | 0.0079 |
| 2 nm | 70 | 7 | 10 | 0.05 |
| 4 nm | 68 | 1 | 68 | 0.34 |

Based on these results, it can be seen that the T % for the devices drastically change with the conductive nanoparticle layer. It can also be seen that, for the device with the buffer layer and conductive nanoparticle layer, there is a greater difference between the T % from the initial state to the on-state at the buffer layer increases from 0 nm to 4 nm.

For the processes and/or methods disclosed, the functions performed in the processes and methods may be implemented in differing order, as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely exemplary, and many other architectures can be implemented which achieve the same or similar functionality.

### Embodiments

The authors of the present disclosure contemplate a number of specific embodiments, including at least the following:

### Embodiment 1

An electrochromic element comprising:

a. A first electrode;

b. A blocking layer;

c. An electrochromic layer;

d. A second electrode, wherein the second electrode can comprise a conductive nanostructured layer disposed upon the electrochromic layer.

### Embodiment 2

The electrochromic element of embodiment 1, wherein the first electrode comprises a transparent conductive metal oxide, and the second electrode comprises a transparent conductive metal oxide, wherein the conductive nanostructured layer is disposed between the second electrode comprising transparent conductive metal oxide and the electrochromic layer.

### Embodiment 3

The electrochromic element of embodiment 1, wherein the conductive nanostructured layer comprises Ag, Cu, Au, or Al.

### Embodiment 4

The electrochromic element of embodiment 1, wherein the conductive nanostructured layer comprises nanoparticles having an average diameter of between 2 nm to 1 μm.

### Embodiment 5

The electrochromic element of embodiment 1, further comprising a buffer layer, the buffer layer disposed between the first electrode and the blocking layer.

### Embodiment 6

The electrochromic element of embodiment 5, wherein the buffer layer comprises non-polymeric organic compound that may comprise an optionally substituted aromatic ring.

### Embodiment 7

The electrochromic element of embodiment 6, wherein the non-polymeric organic compound is

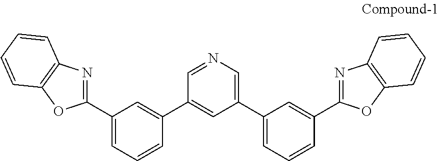 [SMILES: c1cc(-c2cncc(-c3cccc(-c4nc5ccccc5o4)c3)c2)cc(-c2nc3ccccc3o2)c1]

### Embodiment 8

The electrochromic element of embodiment 1, wherein the first electrode element comprises a transparent conductive material.

### Embodiment 9

The electrochromic element of embodiment 8, wherein the transparent conductive material is a metal oxide material.

### Embodiment 10

The electrochromic element of embodiment 9, wherein the metal oxide material is indium tin oxide.

### Embodiment 11

A system, comprising an electrochromic element of embodiment 1, including an electrochromic material, wherein at least one optical property of the electrochromic material may be changed from a first state to a second state upon application of an electric potential, and wherein the device is structured to maintain the at least one optical property of the electrochromic material in the second state without continued application of the electric potential.

### Embodiment 12

The system of embodiment 11, further comprising a power source in electrical communication with the electrodes to provide an electric potential to the electrochromic device.

### Embodiment 13

A method for preparing an electrochromic device comprising:

Providing a first conductive material;

depositing a buffer layer upon the conductive material, the resulting buffer layer having a nanostructured template morphology thereon;

depositing an electrically blocking material layer upon the buffer layer;

depositing an electrochromic layer upon the electrically blocking layer; and

depositing a second conductive material upon the electrochromic layer, the electrically blocking layer and electrochromic layer of sufficient thinness to transfer the nanostructured template morphology from the buffer layer surface and effect a complementary morphology in the conductive layer, the conductive layer having a sufficient complementary surface morphology to effect a localized surface plasmon resonance.

### Embodiment 14

The method of embodiment 13, further comprising electrically connecting the conductive materials to a power source.

### Embodiment 15

The method of embodiment 13, wherein providing a conductive material comprises depositing a metal conductive layer upon a transparent metal oxide layer.

### Embodiment 16

The method of embodiment 15, wherein the metal conducting layer comprises Ag, Au, and/or Al.

### Embodiment 17

The method of embodiment 13, wherein at least one of the depositing steps is by vapor deposition.

### Embodiment 18

The method of embodiment 13, wherein at least one of the depositing steps is by sputtering.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. An electrochromic element, comprising:
a first electrode;
a second electrode;
a blocking layer disposed between the first electrode and the second electrode;
an electrochromic layer disposed between the first electrode and the second electrode; and
a conductive nanoparticle metal layer disposed upon the electrochromic layer.

2. The electrochromic element of claim 1, further comprising a buffer layer between the first electrode and the blocking layer.

3. The electrochromic element of claim 1, wherein the first electrode comprises a transparent conductive metal oxide.

4. The electrochromic element of claim 3, wherein the transparent conductive metal oxide is indium tin oxide.

5. The electrochromic element of claim 1, wherein the blocking layer comprises an electrically insulating material.

6. The electrochromic element of claim 5, wherein the electrically insulating material is Al₂O₃.

7. The electrochromic element of claim 1, wherein the electrochromic layer comprises an inorganic compound or an organic compound.

8. The electrochromic element of claim 7, wherein the inorganic compound is WO₃.

9. The electrochromic element of claim 1, wherein the conductive nanoparticle metal layer comprises Ag, Cu, Au, or Al.

10. The electrochromic element of claim 9, wherein the conductive nanoparticle metal layer is Ag.

11. The electrochromic element of claim 1, wherein the second electrode comprises a transparent conductive metal or metal oxide.

12. The electrochromic element of claim 11, wherein the transparent conductive metal is Al.

13. The electrochromic element of claim 2, wherein the buffer layer comprises a non-polymeric aromatic compound.

14. The electrochromic element of claim 13, wherein the non-polymeric aromatic compound is:

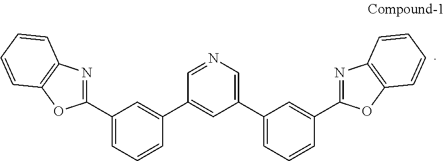 [SMILES: c1cc(-c2cncc(-c3cccc(-c4nc5ccccc5o4)c3)c2)cc(-c2nc3ccccc3o2)c1]

15. The electrochromic element of claim 1, further comprising a protective layer.

16. The electrochromic element of claim 1, wherein:
the electrochromic element has one or more optical properties that can be changed from a first state to a second state upon the application of an electric potential; and wherein the electrochromic element is structured so that the second state is maintained without continued application of the electrical potential.

17. An electrochromic device, comprising:
an electrochromic element of claim 1; and
a power source in electrical communication with the first electrode and the second electrode in order to provide an electric potential to the electrochromic device.

18. The device of claim 17, wherein the buffer layer is deposited on the first electrode in a manner that results in a nanostructured template morphology; and
wherein the deposition of subsequent layers upon the buffer layer are of a suitable thickness such that the nanostructured template morphology of the electrochromic device is maintained in the nanostructured metal layer and the second electrode to effect a localized surface plasmon resonance.

19. A method for preparing an electrochromic device of claim 17 comprising:
providing a substrate;
depositing a first electrode;
depositing a buffer layer upon the first electrode;
depositing a blocking layer upon the buffer layer;
depositing an electrochromic layer upon the blocking layer;
depositing a conductive nanostructured metal layer upon the electrochromic layer;
depositing a second electrode upon the conductive nanostructured metal layer; and
providing a power source in electrical communication with the first electrode and the second electrode in order to provide an electric potential to the electrochromic device.

20. The method of claim 19, wherein at least one of the deposition steps is vapor deposition.
